(19) United States
(12) Patent Application Publication
(10) Pub. No.: US 2009/0030841 A1
(43) Pub. Date: Jan. 29, 2009

(54) CONTENT DELIVERING METHOD, CONTENT DELIVERING SYSTEM, AND CONTENT DELIVERING PROGRAM

(75) Inventors: Hiroshi Sato, Tokyo (JP); Nobuyuki Mukai, Tokyo (JP)

Correspondence Address: YOUNG & THOMPSON, 209 Madison Street, Suite 500, ALEXANDRIA, VA, 22314, US

(73) Assignee: NEC CORPORATION, TOKYO (JP)

(21) Appl. No.: 12/237,916

(22) Filed: Sep. 25, 2008

Related U.S. Application Data
(63) Continuation of application No. 09/909,885, filed on Jul. 23, 2001, now abandoned.

(30) Foreign Application Priority Data
Jul. 21, 2000 (JP) 2000-220150

(51) Int. Cl. H04L 9/00

(52) U.S. Cl. 705/50

(57) ABSTRACT

A content delivering system comprising: a center server for receiving order information relative to the rental of the content data from a user terminal through a network, a delivery server for creating a secret key valid only during a rental period based on the order information and delivering the secret key to a delivery destination terminal, and a content store server for storing a plurality of content data, specifying the content data to be delivered according to an instruction from the delivery server, encrypting the content data to be delivered with the secret key, and sending the same data to the delivery destination terminal.

### BACKGROUNDS OF THE INVENTION

1. Field of the Invention

The present invention relates to a content delivering method and a content delivering system capable of improving the convenience of both a content rental dealer and a customer at rental of content data, and a storing medium with such a content delivering program stored there.

2. Description the Related Art

When a customer rents audio content stored in a storing medium such as a CD and the like and video content stored in a storing medium such as a video cassette, a DVD, and the like, he or she must go to a rental shop on the way home or near his or her house in many cases. FIG. 9 is a view for use in describing the conventional rental form. Hereinafter, audio content and video content may be generally referred to as content simply.

In rental, a customer generally selects a favorite package from a lot of packages displayed on racks and carries it to a reception counter within the rental shop. At this time, a customer is often required to present a membership card indicating that he or she is a rental member. A clerk gets the item number attached on the package and the customer number attached on the membership card to be read out by a controller such as a POS system and the like, collects a rental charge after confirming the rental period, and lends the package to the customer. Here, a package means a jacket and the like for wrapping a storing medium such as a CD, a DVD, and the like with the content data stored therein.

Further, a customer is frequently required to become a rental membership of a rental shop at the initial rental, and at the same time, he or she is frequently requested to make a membership card. At this time, a customer is required to present an identification card with name, telephone number, address, and the like described there, for the purpose of compensation for loss and theft of a rental item. As this identification card, there are, for example, driver's license, a student identification card, and the like. Further, a customer is sometimes required to subscribe to a subscriber line when joining a member, for the above same purpose.

In the above rental form, a customer must return a package, since it is a rental package, to the rental shop by the expiration date of a rental period. Namely, a customer is required to go to a rental shop at least twice when borrowing and returning it, which becomes a troublesome labor.

Even if a customer visits a rental shop to desire the rental of some package, he or she cannot rent the desired package in vain in some cases: for example, where the rental shop doesn't deal with the package or where it is now out for rent by another customer and he or she must wait for it by the return date. Especially, on the rental start date of a popular package of current topic, there often occurs the above situation. If a customer visits a rental shop earlier than any other customer, he or she can rent a desired package. This conventional rental form that “first come, first win”, however, is inconvenient for businessmen and the like on the way home.

In some cases, a customer may be is required to subscribe to a subscriber line when joining a rental member, and the basic charge as well as the installation charge are required in subscribing to the subscriber line. Especially, this basic charge itself burdens a person living alone because such person is often absent from his or her house. A person living alone, however, is a main customer in the rental business. Under these circumstances, this economical burden can be an obstacle to securing customers, also for a dealer of renting content data (hereinafter, referred to as a content rental dealer).

On the other hand, a content rental dealer is required to secure a site for a shop when starting this business. At this time, many content rental dealers are required to secure a large site or a large floor for a shop in order to display many rental packages. Since a customer directly visits a shop, a shop must be located on a place of good geographical conditions, such as in front of a station, along a big street, and the like. Therefore, a person who starts the content rental business is burdened with extravagant initial investment.

Further, in the content rental dealer, since responding to customer's wide taste is a requisite for increasing sales, a content rental dealer needs to prepare a wide range of various packages, and needs to secure the number of the packages which are likely to increase the demand for rental at a special period, so as to gain the maximum achievement results at the period. Therefore, it is necessary for a content rental dealer to secure the latest package released in every week, every month, and the like and at the same time to secure the package having the demand for rental though it is old. Accordingly, a content rental dealer necessarily has an extremely large stock of packages and he or she is troubled with the adequate number of stocks and selection of a package expected to get a good achievement result. Namely, a content rental dealer may be sometimes troubled with harmony of the cost of securing the stock and the achievement results for the cost.

### SUMMARY OF THE INVENTION

Then, in order to solve the above problems, the present invention aims to provide a content delivering method and a content delivering system capable of improving the convenience of both a content rental dealer and a customer at rental of content data, and a storing medium with such a content delivering program stored therein.

According to the first aspect of the invention, a content delivering method for providing information to a customer through the Internet, wherein

a content rental dealer provides a customer with a secret key valid only during a rental period and encrypted content data, in rental of content data, and

a customer reproduces the content data with the secret key.

In the preferred construction, the content delivering method comprising the steps of

creating a secret key valid only during a rental period, based on received order information about rental of content data,

specifying the content data to be delivered based on the order information,

encrypting the specified content data to be delivered, and

sending the secret key and the encrypted content data to a delivery destination terminal.

In another preferred construction, a content rental dealer induces a customer to select a payment method of a rental charge, hence to settle up the rental charge according to the payment method selected by the customer.

In another preferred construction, a content rental dealer checks customer's credit authorization through access to a credit authorization network built by financial institutions, in settlement of a rental charge.

In another preferred construction, a content rental dealer induces a customer to select a payment method of a rental charge, hence to settle up the rental charge according to the payment method selected by the customer, and a content rental dealer checks customer's credit authorization through access to a credit authorization network built by financial institutions, in settlement of a rental charge.

In another preferred construction, payment is performed by a credit card, a tie-up card of financial institutions, electronic money, or payment confirmation into a specified account of a financial institution.

In another preferred construction, a content rental dealer presents advertisement information to a customer.

In another preferred construction, a content rental dealer selects the advertisement information to each customer's taste, based on accumulated customer information, hence to send the same information to each customer via electronic mail.

In another preferred construction, a content rental dealer creates customer's taste data by classifying the accumulated customer information into predetermined items.

In another preferred construction, a content rental dealer collects an information supply charge by supplying the customer's taste data to another.

According to the second aspect of the invention, a content delivering system for delivering information to a delivery destination terminal through the Internet, comprises

a server for receiving order information relative to rental of content data from a customer terminal, creating a secret key valid only during a rental period based on the order information, and delivering the secrete key to the delivery destination terminal specified by a customer, and

a content store server for storing a plurality of content data, encrypting the content data to be delivered and delivering the same data to the delivery destination terminal according to an instruction from the server.

In the preferred construction, the order information includes item number of content data, its rental period, and address of the delivery destination terminal, and delivery start time and date or secret key delivery time and date of the content data.

In another preferred construction, the server delivers advertisement data to the delivery destination terminal.

In another preferred construction, the content store server delivers advertisement data, which is attached to the content data, to the delivery destination terminal.

In another preferred construction, the server notifies the item number of the content data and the address of the delivery destination terminal to the content store server, in a delivery instruction of the content data.

In another preferred construction, the server creates customer identification information indicating a correspondence between a customer and order content, from the order information, classifies the customer identification information into predetermined items, and stores the same information.

According to the third aspect of the invention, a content delivering server for delivering information to a delivery destination terminal through the Internet, comprises

a first server for receiving order information relative to rental of content data from a customer terminal, creating a secret key valid only during a rental period based on the order information, and delivering the secrete key to the delivery destination terminal specified by a customer, and

a second server for storing a plurality of content data, encrypting the content data to be delivered and delivering the same data to the delivery destination terminal according to an instruction from the server.

In the preferred construction, the order information includes item number of content data, its rental period, and address of the delivery destination terminal, and delivery start time and date or secret key delivery time and date of the content data.

In another preferred construction, the first server delivers advertisement data to the delivery destination terminal.

In another preferred construction, the second server delivers advertisement data, which is attached to the content data, to the delivery destination terminal.

In another preferred construction, the first server notifies the item number of the content data and the address of the delivery destination terminal to the second server, in a delivery instruction of the content data.

In another preferred construction, the first server creates customer identification information indicating a correspondence between a customer and order content, from the order information, classifies the customer identification information into predetermined items, and stores the same information.

According to another aspect of the invention, a content delivering program for delivering information to a destination terminal through the Internet, comprising the functions of

creating a secret key valid only during a rental period, based on received order information about rental of content data,

specifying the content data to be delivered based on the order information,

encrypting the specified content data to be delivered, and

sending the secret key and the encrypted content data to the delivery destination terminal.

Other objects, features and advantages of the present invention will become clear from the detailed description given herebelow.

### BRIEF DESCRIPTION OF THE DRAWINGS

The present invention will be understood more fully from the detailed description given herebelow and from the accompanying drawings of the preferred embodiment of the invention, which, however, should not be taken to be limitative to the invention, but are for explanation and understanding only.

In the drawings:

FIG. 1 is a constitutional block diagram showing a constitutional example of a content delivering system using the present invention;

FIG. 2 is a sequence view for use in describing the operation of the system shown in FIG. 1;

FIG. 3 is a flow chart for use in describing the operation of a customer;

FIG. 4 is an explanatory view showing an example of a selection screen;

FIG. 5 is an explanatory view showing an example of a selection screen;

FIG. 6 is an explanatory view showing an example of a settlement confirmation screen;

FIG. 7 is an explanatory view showing an example of an order information confirmation screen;

FIG. 8 is an explanatory view showing an example of the content data;

FIG. 9 is an explanatory view for use in describing the conventional rental form.

### DESCRIPTION OF THE PREFER

The preferred embodiment of the present invention will be discussed hereinafter in detail with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to unnecessary obscure the present invention

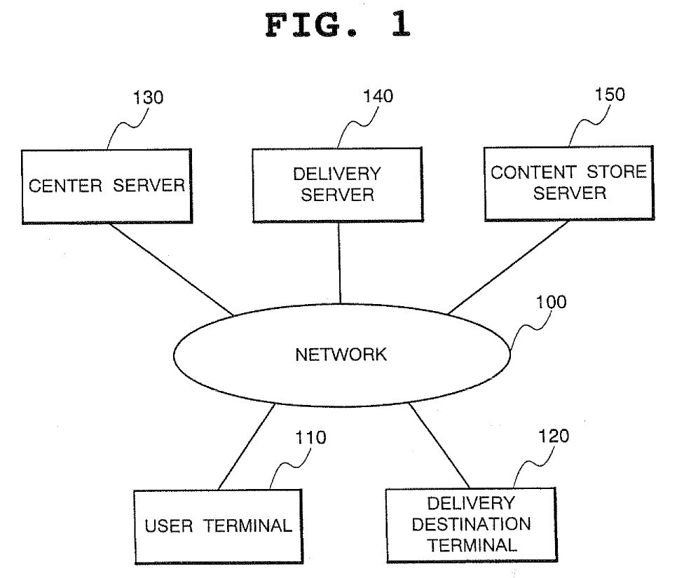

FIG. 1 is a constitutional block diagram showing a constitutional example of a content delivering system by use of the present invention.

In the content delivering system shown in FIG. 1, a network 100 represented by the Internet connects a user terminal 110, a delivery destination terminal 120, a center server 130, a delivery server 140, and a content store server 150.

The user terminal 110 and the delivery destination terminal 120 are, for example, an information terminal such as a personal computer, etc. and a telephone terminal such as a portable telephone terminal, etc. provided with a function connectable to the Internet. Here, when the user terminal 110 or the delivery destination terminal 120 is the information terminal, the WWW browser and the like that is the connecting software to the Internet is incorporated into the user terminal 110 or the delivery destination terminal 120.

The user terminal 110 exchanges information between the center server 130 and itself through the network 100. The delivery destination terminal 120 receives the information sent from the delivery server 140 and the content store server 150 through the network 100.

The center server 130 and the delivery server 140 is managed and controlled by a content rental dealer, and they are formed by, for example, an information processing device such as a workstation server. The content store server 150 is managed and controlled by a content rental dealer and it is formed by, for example, an information processing device such as a workstation server and a media storing device such as a disk unit.

The center server 130 exchanges information between the delivery server 140 and itself based on the information sent from the user terminal 110. The delivery server 140 sends the information to the delivery destination terminal 120 and the content store server 150 through the network 100. The content store server 150 stores a lot of content data and sends the specified content data to the delivery destination terminal 120 according to an instruction from the delivery server 140.

Assume that a content delivering program for delivering content data to the delivery destination terminal 120 according to an instruction from the user terminal 110 is stored in the center server 130, the delivery server 140, and the content store server 150. In the example shown in FIG. 1, although the description has been made in the case where the center server 130, the delivery server 140, and the content store server 150 are respectively independent, the respective functions of the center server 130, the delivery server 140, and the content store server 150 may be realized by the same server.

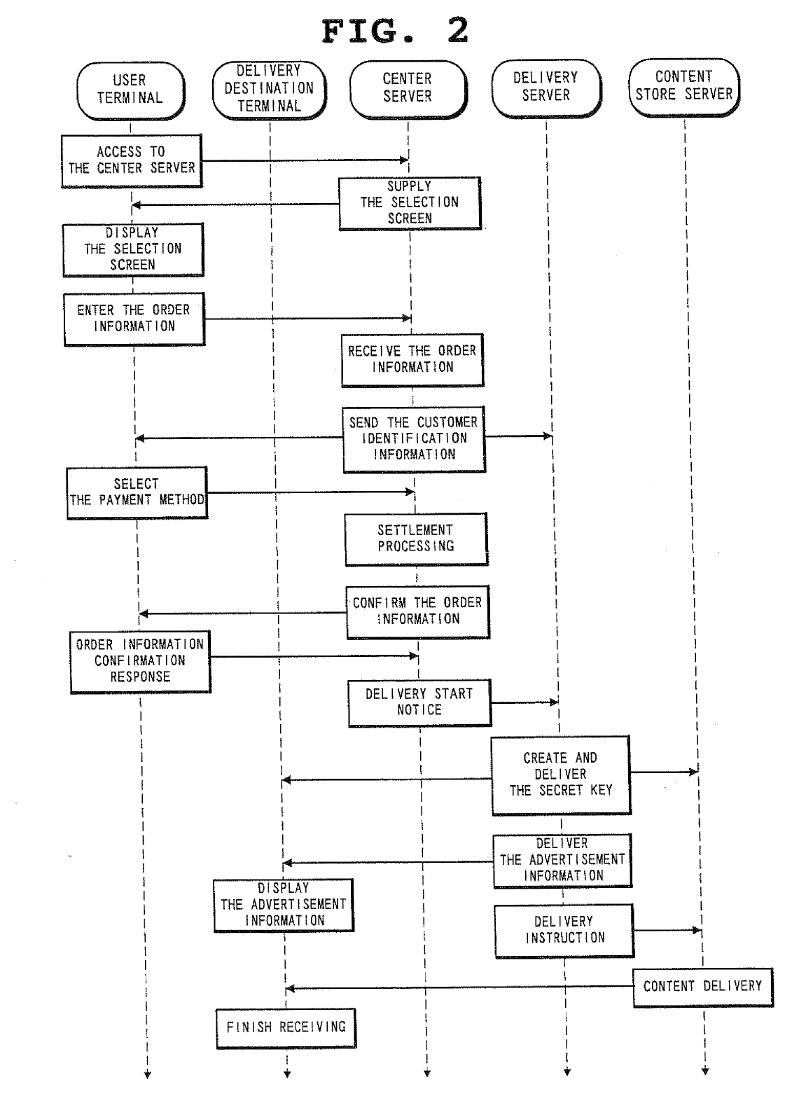

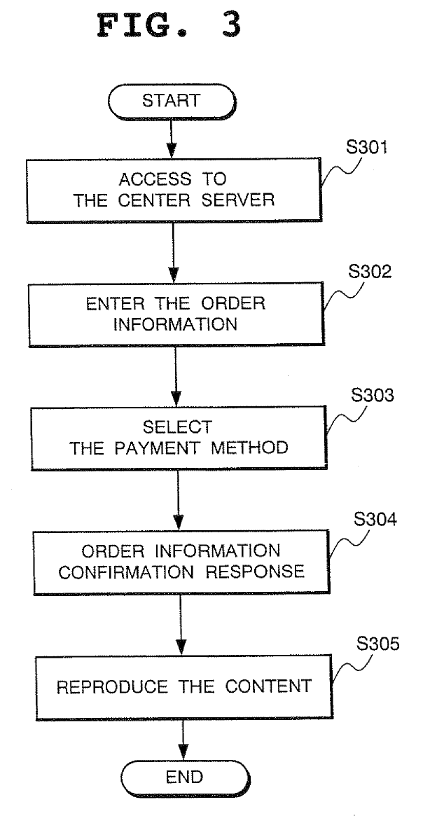

The operation will be described this time. Here, the description will be made, by way of example, in the case where the delivery destination of content data is the delivery destination terminal 120. Further, assume that the delivery destination terminal 120 is an information processing terminal. FIG. 2 is a sequence view for use in describing the operation of the system shown in FIG. 1. FIG. 3 is a flow chart for use in describing the operation of a customer.

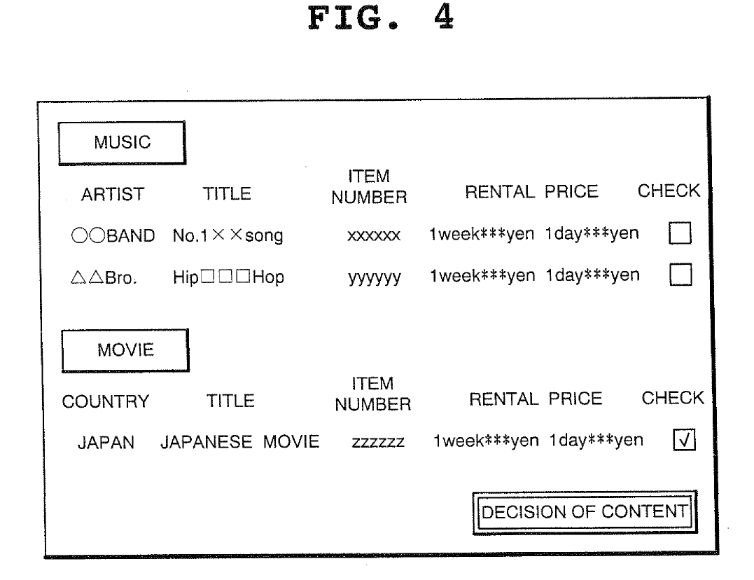

The user terminal 110 gains access to an order acceptance home page which the center server 130 opens on the network 100, according to an instruction from a customer (Step S301). The center server 130 provides the user terminal 110 with a selection screen relative to the rental of content data. The selection screen as shown in FIG. 4 appears on the display unit of the user terminal 110. FIG. 4 is an explanatory view showing an example of the selection screen.

In the example shown in FIG. 4, the content is classified into two types: “music” and “movie”. In the “music”, the title of the content is classified into artists, and on each title, there are item number, rental price, and check column correspondingly. In the “movie”, the title of the content is classified into produced countries, and on each title, there are item number, rental price, and check column correspondingly, in the same way as in the case of the “music”. In both the “music” type and the “movie” type, a mark attached to the check column means that the corresponding content is desired for rental. The mark is attached by the mouse operation and the like. In the example shown in FIG. 4, the content of the title “Japanese movie” is selected as a rental object and a content decision button shown in the bottom right of the screen is pressed by the mouse operation and the like.

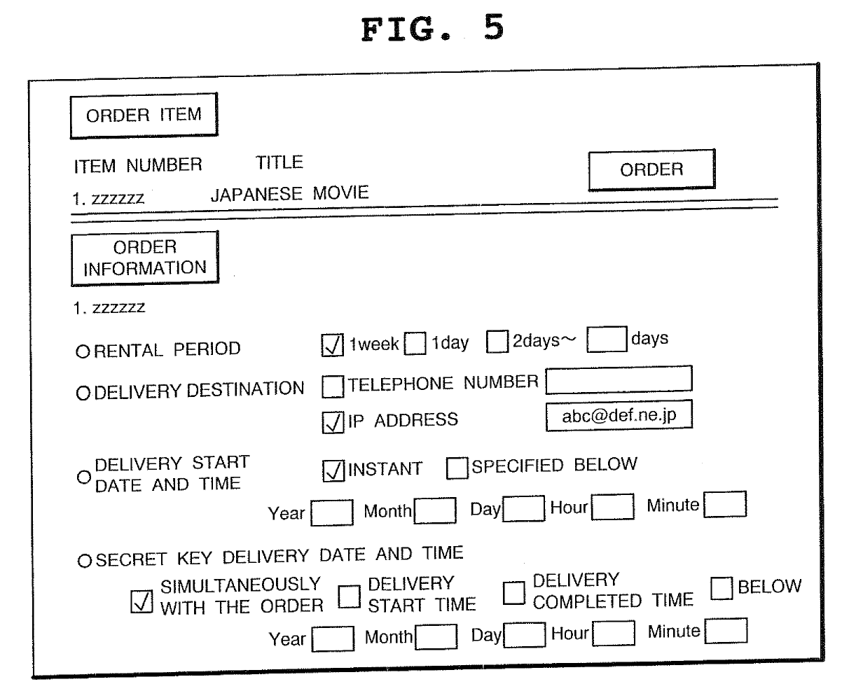

Then, a screen as shown in FIG. 5 appears on the display unit of the user terminal 110. FIG. 5 is an explanatory view showing one example of a selection screen. A customer enters the order information relative to the rental of the content data on this screen (Step S302). The input is made by a keyboard operation and the like. In the example shown in FIG. 5, there are “rental period”, “delivery destination”, “delivery start date and time”, and “secret key delivery date and time”, as the order information.

The “rental period” indicates the rental period of the content data, and a customer can select one from one week, one day, two days, and a customer's desired period. The “delivery destination” indicates the address of a terminal of a delivery destination of the content data (phone number). That is, in the form of this embodiment, it means the address of the delivery destination terminal 120. When the delivery destination terminal 120 is a telephone terminal, the telephone number of the corresponding terminal is supplied to the “delivery destination”, and when the delivery destination terminal 120 is an information terminal such as a personal computer, the Internet address of the corresponding terminal is supplied to the “delivery destination”.

The “delivery start date and time” indicates the delivery start date and time of the content data, and a customer can select one from “instant” and “customer's desired date and time (specified below)”. The “secret key delivery date and time” indicates the delivery date and time of a secret key necessary for reproducing the content data, and a customer can select one from “simultaneously with this order”, “delivery start time and date”, “delivery completed date and time”, and “customer's desired date and time (specified below)”. The “secret key delivery date and time” has the detailed selection items as the above, because the contract as for the rental period is effected at a delivery completed point of a secret key. This takes into consideration, a risk of delivery interruption due to a network accident occurring during the delivery of the content data to the delivery destination terminal 120, and the difference of access bandwidth between the delivery destination terminal 120 and the network 100.

Prior to order, a customer must register the profile including the name, the phone number, the address, and the electronic mail address into the center server 130. This profile may be registered there separately from the input of the order information (from another screen not illustrated), or it may be registered into the center server 130 prior to the input of the order information.

After entering the order information as shown in the above, a customer presses the order button displayed on the top right on the screen by the mouse operation and the like. Here, assume that the order information is selected as shown in FIG. 5. Then, the user terminal 110 sends the order information to the center server 130. The center server 130 creates customer identification information for identifying a person who made an order (customer) and the order content from the received order information. Namely, it creates the information indicating the correspondence between the person who made an order and the order content.

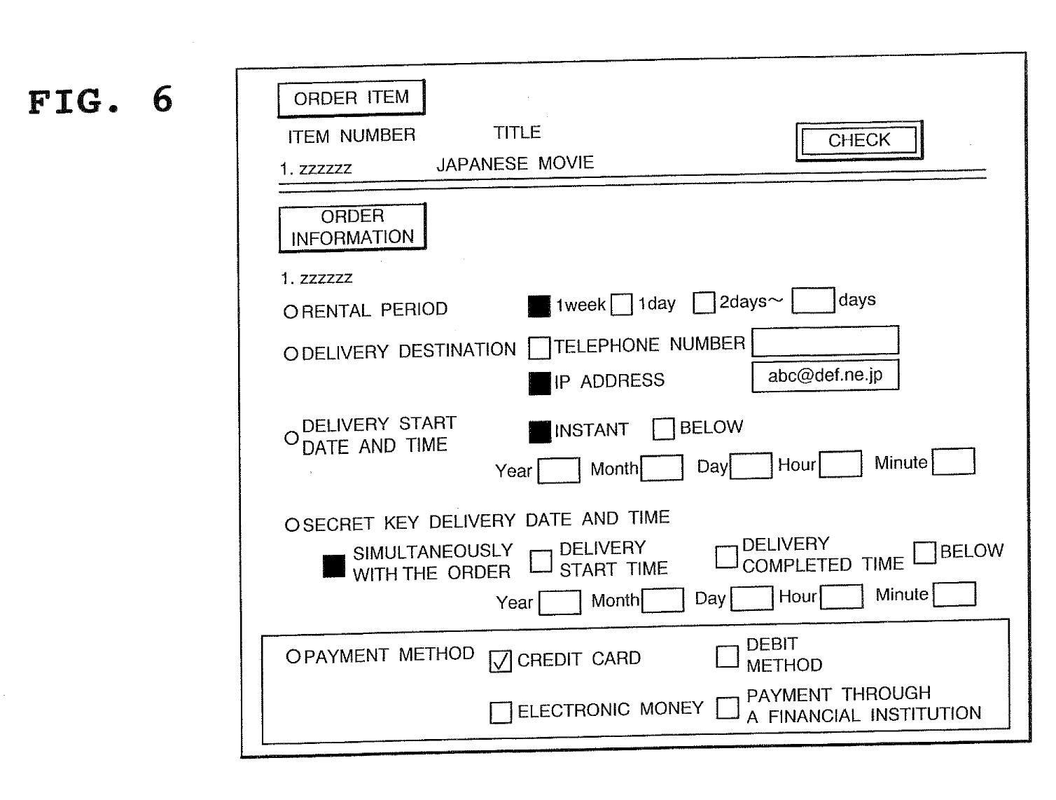

The center server 130 stores the created customer identification information into a storing medium such as a database and the like provided therein. The customer identification information is sequentially stored in every order. Alternatively, the center server 130 may store the customer identification information with the same information classified into every item for the purpose of easy classification and collection of the data. The predetermined item includes, for example, sex, generation, and occupation of a customer. The center server 130 sends the customer identification information to the delivery server 140. It also sends the same information to the user terminal 110, in order to confirm the order information. At this time, the settlement confirmation screen as shown in FIG. 6 is represented on the display unit of the user terminal 110. FIG. 6 is an explanatory view showing an example of the settlement confirmation screen.

In the settlement confirmation screen shown in FIG. 6, a column for a payment method is displayed, in addition to the selected result on the selection screen shown in FIG. 5. As the payment method, there are four types: “credit card”, “debit method”, “electronic money” and “payment through a financial institution”. A customer selects any payment method from these payment methods (Step S303). The selection is made by marking the check column corresponding to the desired payment method with the mouse operation and the like.

When the “credit card” is selected as the payment method, a screen for entering the number of a credit card and the like appears on the display unit of the user terminal 110. When the “debit method” is selected, a screen for entering a specified bank, a specified account number, and the like appears there. When the “electronic money” is selected, a screen for entering the account number and the like of the electronic money account appears there. When the “payment through a financial institution” is selected, a payment sheet and the like is separately sent from the content rental dealer to the customer.

A customer selects the payment method and presses a reference button displayed on the top right of the screen by the mouse operation and the like after entering the necessary information. Then, the user terminal 110 sends the settlement confirmation information previously supplied, to the center server 130. The center server 130 performs the settlement processing of a rental charge based on the received settlement confirmation information.

When the “credit card” is selected as the payment method, the center server 130 checks the credit authorization of the customer by having access to a credit authorization network built by a credit card company and the like, and when the credit of the customer can be verified, it settles up the rental charge.

When the “debit method” is selected, the center server 130 sends the information such as the account number and the like of the customer to a gateway provided in the customer's financial institution, and withdraws the rental charge out of the customer's bank account through a credit authorization network built by a financial institution and the like.

When the “electronic money” is selected, the center server 130 withdraws the rental charge out of the customer's electronic money account, in the same procedure as in the debit method”.

When the “payment through a financial institution” is selected, the content rental dealer sends a payment description sheet and a predetermined payment sheet to a customer's address or residence. The content rental dealer settles up the rental charge when confirming that the rental charge has been actually paid. This confirmation may be performed by the content rental dealer's filling the bankbook or by a notice through a telephone from the financial institution.

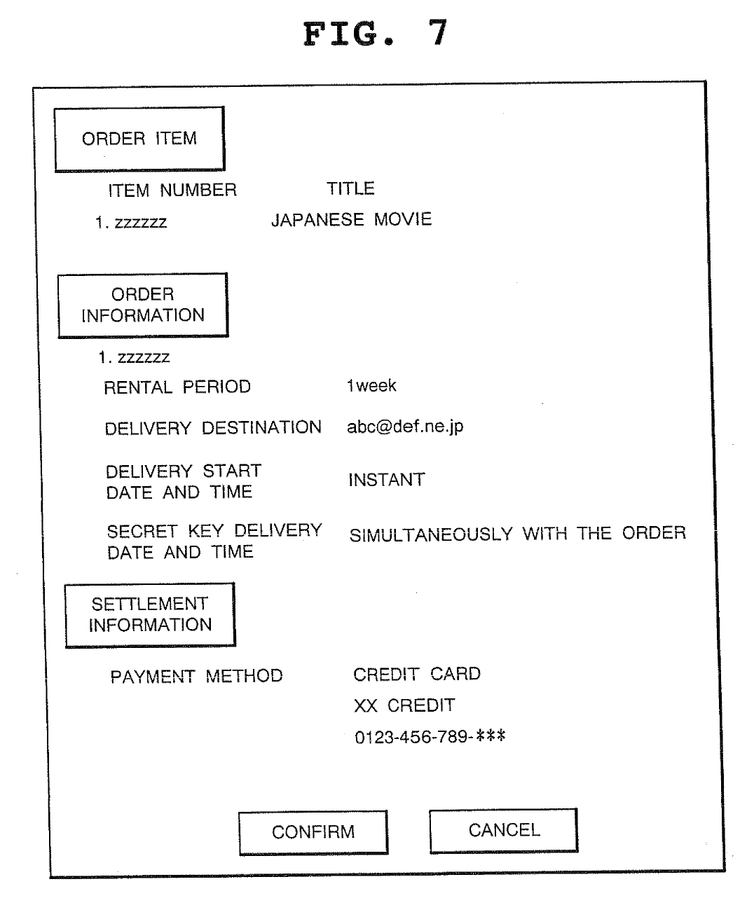

The center server 130 displays an order information confirmation screen as shown in FIG. 7 on the display unit of the user terminal 110 after the settlement of the rental charge. FIG. 7 is an explanatory view showing an example of the order information confirmation screen. A customer who made an order presses a confirmation button by the mouse operation and the like if there is no problem in the displayed content on the order information confirmation screen, and when he or she wants to cancel the order, he or she presses a cancel button (Step S304). The user terminal 110 sends the information about whether the confirmation button is pressed or the cancel button is pressed, to the center server 130. If the settlement of the rental charge is impossible, the center server 130 may stop the processing hereafter and it may notify the user terminal 110 to the effect that the selection procedure of the payment method should be tried again.

When the cancel button is pressed, the center server 130 stops the processing hereafter. At this time, it may notify the user terminal 110 to the effect that the ordering procedure will be tried again. When the confirmation button is pressed, the center server 130 notifies the delivery server 140 of the delivery start.

Upon receipt of the delivery start notice, the delivery server 140 creates a secret key with the term of validity, which is effective only within the rental period. The secret key includes a time stamp at a content deliver time and a time stamp of the validity term as the internal information. The time stamp may adopt the value of a timer in an information terminal such as a personal computer as the standard, and it may adopt the absolute time on the Internet as the standard. Since the “secret key delivery date and time” is “simultaneously with this order”, the delivery server 140 sends thus created secret key to the delivery destination terminal 120 and the content store server 150. The delivery destination terminal 120 and the content store server 150 hold the received secret key as a secret key file.

Considering that the “instant” is selected as the “delivery start date and time”, the delivery server 140 creates advertisement data in a script language such as Java, and sends the data to the delivery destination terminal 120 prior to the delivery of the content data. The delivery destination terminal 120 displays the received advertisement data on the display unit as the advertisement information (attached information). This advertisement information as the attached information may be displayed until delivery of the content data starts, or until delivery of the content data is completed. The delivery server 140 may stop the delivery of the advertisement information at any time.

The advertisement information is to be provided by an advertising company and the like, and it includes, for example, information about new content and well-selling content, and specified information for each generation. The content rental dealer may demand a predetermined advertisement charge of the advertising company, for the cost of showing this advertisement information to a customer. At this time, the whole or one of the collected advertisement charge may be passed on to a customer in a rental charge.

The delivery server 140 instructs the content store server 150 to deliver the content. At this time, the delivery server 140 sends the item number of the ordered content data and the delivery destination specified information (address of the delivery destination terminal 120) to the content store server 150. The content store server 150 can specify the content data to be delivered, according to the item number and the delivery destination specified information (address of the delivery destination terminal 120).

The content store server 150 extracts the content data to be delivered, from a plurality of stored content data, and encrypts the content data to be delivered, by using the secret key previously received. The encrypted content data is sent to the delivery destination terminal 120. The delivery destination terminal 120 may receive the specified content data from the content store server 150, by having access to the delivery server 140 at a predetermined date and time.

The delivery destination terminal 120 stores the received content data into a storing medium such as a hard disk. Assume that reproducing software for reproducing the received content data is built in the delivery destination terminal 120. This reproducing software is sent to the delivery destination terminal 120, for example, prior to the delivery of the content data.

In the above form of the embodiment, although the description has been made, by way of example, in the case where the “delivery start date and time” is “instant” and the “secret key delivery date and time” is “simultaneously with this order”, when the “delivery start date and time” is “customer's desired date and time”, the advertisement data may be sent to the delivery destination terminal 120 by that time. Even when the “secret key delivery date and time” is “delivery start time”, “delivery completed time”, or “customer's desired date and time”, the operation is the same as the operation as mentioned above.

Here, the delivery destination terminal 120 is specified as the delivery destination of the content data, in consideration for a difference in the content storing capacity and the transfer capacity between the user terminal 110 and the delivery destination terminal 120. For example, when the user terminal 110 is a telephone terminal such as a portable telephone terminal, if the user terminal 110 is specified as the delivery destination of the content data, it takes much time to transfer the data because the data transfer rate is low and hence the communication charge becomes expensive disadvantageously. In order to solve this disadvantage, a terminal having a good transfer condition of the content data is defined as the delivery destination terminal 120. However, when there is not so much difference in the transfer condition of the content data between the user terminal 110 and the delivery destination terminal 120, the user terminal 110 may be the delivery destination of the content data.

A customer activates the reproducing software built in the delivery destination terminal 120 (Step S305) when enjoying the content during the rental period. At this time, if the content data can be reproduced, the reproducing software decodes and reproduces the content data, by reference to the secret key file. When the rental period expired, the reproducing software cannot reproduce the content data since the secret key file has been invalidated.

Since the content data whose rental period expired cannot be reproduced, a customer is released from the conventional trouble of returning back the content data. Further, a customer may delete such content data that cannot be reproduced. Alternatively, the reproducing software may delete such content data.

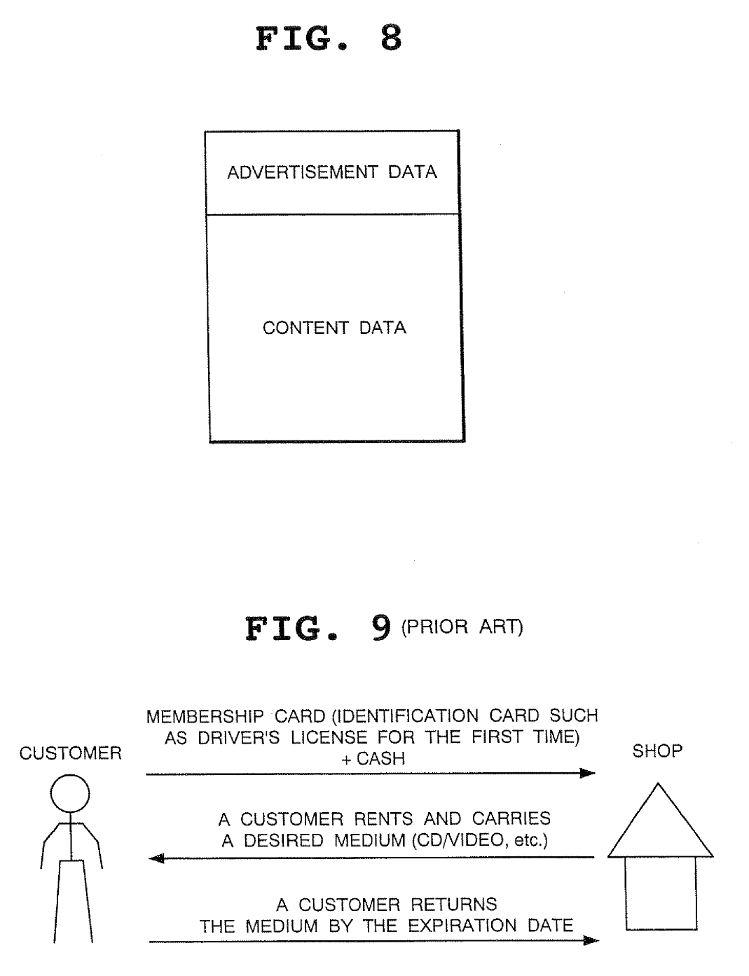

Although the above form of the embodiment has shown the example in which the delivery server 140 sends the advertisement information to the delivery destination terminal 120, the content store server 150 may add the advertisement data to the content date to be delivered as shown in FIG. 8. FIG. 8 is an explanatory view showing an example of the content data. This content data is sent to the delivery destination terminal 120, thereby showing the advertisement information to a customer, before or after the playback of the ordered content data. At this time, the content rental dealer can also collect the advertisement charge from an advertising company and the like.

The content rental dealer may receive the advertisement information such as release information and event information collectively from an advertising company and the like, and by reference to the customer identification information of all the customers stored in the center server 130, it may select the information to the taste of each customer from the advertisement information and send the information to the corresponding customer (the user terminal 110 or the delivery destination terminal 120) via electronic mail. At this time, the content rental dealer may collect a predetermined charge from an advertising company and the like as the agent charge. Further, it may supply customers taste data in which the data is classified into each category such as sex, age, and occupation based on the customer identification information of all the customers, to a record company, a movie company, and the like.

Also at this time, the content rental dealer may collect the information supply charge from a record company, a movie company, and the like. The content rental dealer may pass on the whole or some of thus collected agent charge or information supply charge to a customer into a rental charge. Therefore, a customer can rent content data at a low price, by the content rental dealer's returning the whole or some of the collected agent charge or information supply charge to a rental charge.

As mentioned above, according to the form of the embodiment, a content rental dealer is provided with the center server 130, the delivery server 140, and the content store server 150, thereby making it possible to supply the content data to the delivery destination terminal 120. Therefore, it is not necessary for the content rental dealer to secure a site for a shop when staring this business, and to bear the cost of the initial investment, maintenance, man power, and the like. Further, since the same content data can be supplied to a plurality of customers through the network 100, it is not necessary for the content rental dealer to prepare a plurality of packages of the same content like the conventional rental shop, thereby reducing the labor in stock control.

Further, a customer can receive the desired content data at a desired date and time from the content rental dealer by the delivery destination terminal 120 through the network 100. The content data is encrypted by the secret key with validity term, and the delivery destination terminal 120 can reproduce the content data by using the secret key only during the rental period. Accordingly, a customer doesn't need to go to a shop to rent the content data.

Further, a content rental dealer checks customer's credit authorization through access to a credit authorization network built by a financial company and the like based on the specified information stored in a customer's credit card. After the check of the credit authorization, it settles up a rental charge according to the payment method specified by a customer. Accordingly, even in the case of the first time rental, it is not necessary for a customer to present his or her identification card, for registration of membership, and to subscribe to a subscriber line, unlike in the conventional way.

The delivery server 140 sends the advertisement data to the delivery destination terminal 120 prior to the delivery of the content data. Alternatively, the content store server 150 may send the advertisement data, which is attached to the content data, to the delivery destination terminal 120. At this time, the content rental dealer can earn an income other than a rental charge by collecting the advertisement charge from an advertising company. A customer can rent the content data at a low price by the content rental dealer's returning the whole or some of the charge thus collected by the content rental dealer to a rental charge.

Further, the content rental dealer can create the customer's taste information and the like based on the customer identification information of all the customers stored in the center server 130 and provide this information to another dealer. Additionally, receiving the advertisement information collectively from another dealer, the content rental dealer can select some information to the taste of each customer from the advertisement information, according to the customer identification information of all the customers stored in the center server 130, and send the selected information to the corresponding customer via electronic mail. In the above case, the content rental dealer can collect a predetermined charge from another dealer. Similarly to the case as mentioned above, the whole or some of thus collected charge can be returned to a rental charge.

Such a business form is being increased, that the audio data encoded by the MP3 (MPEG1 audio layer3) method and the like is sold by every one piece to a customer through the Internet and the like. According to the present invention, since the content data such as the audio data and the like is provided to a customer in a rental way, a customer can receive the rental service of the content data at a lower price than that in the case of the purchase.

According to the present invention, provided with a server and a content store server, the content rental dealer can provide a customer with the customer's desired content data through the Internet. Therefore, it is not necessary for the content rental dealer to secure a site for a shop when starting the business. Accordingly, the content rental dealer doesn't need to bear the cost of shop maintenance and man power. Since one content data can be supplied to a plurality of customers, the present invention can reduce the labor in stock control. On the other hand, a customer can rent his or her desired content data at his or her convenient time favorably.

Since the content date provided to a customer is encrypted by a secret key only valid during a rental period, a customer can enjoy the content data only within the rental period. Accordingly, a customer is released from a trouble of going to a shop in order to rent the content data.

Further, the content rental dealer gains access to a credit authorization network built by a financial institution and the like in the rental of the content data, so as to check a customer's credit authorization, and hence settles up a rental charge in a way specified by a customer. Accordingly, the content rental dealer can collect a rental charge surely. While, a customer is not required to present his or her identification card such as a driver's license and a student identification card, for check of his or her credit authorization, even in the case of renting the content data for the first time.

The content rental dealer can collect an advertisement charge from an advertiser, in return for showing advertisement information to a customer. Further, the content rental dealer can select the information to the taste of each customer, from the advertisement information collectively received from an advertiser, according to the accumulated order information of each customer, and send the selected information to the corresponding customer via electronic mail, thereby collecting an agent charge from the advertiser. Further, the content rental dealer can create customer's taste data by classifying the accumulated order data of each customer into sex, generation, occupation, and the like, and provide the customer's taste data to another, thereby collecting information supply charge from another. Accordingly, the content rental dealer can earn an income other than a rental charge. While, a customer can rent the content data at a lower price, by the content rental dealer's returning the whole or some of thus obtained income to a rental charge.

Although the invention has been illustrated and described with respect to exemplary embodiment thereof, it should be understood by those skilled in the art that the foregoing and various other changes, omissions and additions may be made therein and thereto, without departing from the spirit and scope of the present invention. Therefore, the present invention should not be understood as limited to the specific embodiment set out above but to include all possible embodiments which can be embodies within a scope encompassed and equivalents thereof with respect to the feature set out in the appended claims.

1. A method of delivering rented content data to a customer through the internet, the method comprising the steps of:
defining, by the customer, a rental period during which access to the content data is to be permitted;
providing from a dealer to the customer a secret key that is useable only during the rental period defined by the customer;
providing from the dealer to the customer the content data in encrypted form through the internet; and
at the customer, decrypting and reproducing the content data provided from the dealer using the secret key during the rental period.

2. The method of claim 1, further comprising the step of charging the customer for access to the content data based on the rental period defined by the customer.

3. The method of claim 1, further comprising the step of providing from the dealer to the customer advertisement information in association with the provided content data.

4. The method of claim 3, further comprising the step of selecting the advertisement information based on information about the customer.

5. The method of claim 1, wherein the defining step includes the step of the customer selecting a time for delivery of the secret key to the customer.

6. The method of claim 1, wherein the defining step includes the step of the customer selecting a time for delivery of the content data to the customer.

7. A system for delivering rented content data to a customer through the internet, comprising:
a first server that receives a rental period during which access to the content data is to be permitted, the rental period being defined by the customer, and that provides to the customer a secret key that is useable only during the rental period defined by the customer;
a content store server communicating with the first server and that provides from the dealer to the customer the content data in encrypted form through the internet; and
a customer terminal communicating with the content store server and the first server and that decrypts and reproduces for the customer the content data provided from the dealer using the secret key during the rental period.

8. The system of claim 7, wherein the first server charges the customer for access to the content data based on the rental period defined by the customer.

9. The system of claim 7, wherein the first server also receives a time for delivery of the secret key to the customer that is defined by the customer.

10. The system of claim 7, wherein the first server also receives a time for delivery of the content data to the customer that is defined by the customer.

11. A program for carrying out a method of delivering rented content data to a customer through the internet, the program including instructions for carrying out the steps of:
defining, by the customer, a rental period during which access to the content data is to be permitted;
providing from a dealer to the customer a secret key that is useable only during the rental period defined by the customer;
providing from the dealer to the customer the content data in encrypted form through the internet; and
at the customer, decrypting and reproducing the content data provided from the dealer using the secret key during the rental period.

12. The program of claim 11, further comprising the step of charging the customer for access to the content data based on the rental period defined by the customer.

13. The program of claim 11, further comprising the step of providing from the dealer to the customer advertisement information in association with the provided content data.

14. The program of claim 13, further comprising the step of selecting the advertisement information based on information about the customer.

15. The program of claim 11, wherein the defining step includes the step of the customer selecting a time for delivery of the secret key to the customer.

16. The program of claim 11, wherein the defining step includes the step of the customer selecting a time for delivery of the content data to the customer.
